(19) United States
(12) Patent Application Publication
(10) Pub. No.: US 2024/0179541 A1
(43) Pub. Date: May 30, 2024

(54) OPTIMIZATION METHOD AND APPARATUS IN UNMANNED AERIAL VEHICLE BASED COMMUNICATION NETWORK

(71) Applicant: ELECTRONICS AND TELECOMMUNICATIONS RESEARCH INSTITUTE, Daejeon (KR)

(72) Inventors: Ji Eun YU, Seoul (KR); Kwang Myeong YANG, Seoul (KR); Kyu Yeon LEE, Seoul (KR); Cha Hyeon EOM, Seoul (KR); Hyung Je LEE, Seoul (KR); Chung Yong LEE, Seoul (KR); Duk Hyun YOU, Daejeon (KR); Hoon Dong NOH, Daejeon (KR)

(73) Assignee: ELECTRONICS AND TELECOMMUNICATIONS RESEARCH INSTITUTE, Daejeon (KR)

(21) Appl. No.: 18/523,561

(22) Filed: Nov. 29, 2023

(30) Foreign Application Priority Data
Nov. 30, 2022 (KR) 10-2022-0164694
May 22, 2023 (KR) 10-2023-0065803
Nov. 28, 2023 (KR) 10-2023-0168392

(51) Int. Cl. H04W 24/02; H04B 17/336; H04L 43/06

(52) U.S. Cl. CPC H04W 24/02; H04B 17/336; H04L 43/06; H04W 84/06

(57) ABSTRACT

A method of a first communication node may comprise: transmitting, to a second communication node, an initiation signal indicating to initiate a collection procedure of training data for a neural network; transmitting, to the second communication node, an information signal including network parameters of the first communication node; receiving, from the second communication node, the training data in response to the information signal; training the neural network using the training data; determining optimal network parameters using the trained neural network; and performing communication with the second communication node using the optimal network parameters.

### CROSS-REFERENCE TO RELATED APPLICATIONS

This application claims priority to Korean Patent Applications No. 10-2022-0164694, filed on Nov. 30, 2022, No. 10-2023-0065803, filed on May 22, 2023, and No. 10-2023-0168392, filed on Nov. 28, 2023, with the Korean Intellectual Property Office (KIPO), the entire contents of which are hereby incorporated by reference.

### BACKGROUND

### 1. Technical Field

Exemplary embodiments of the present disclosure relate to a network optimization technique, and more specifically, to a network optimization technique for improving communication performance in an unmanned aerial vehicle (UAV)-based communication network.

### 2. Related Art

The communication system (e.g. a new radio (NR) communication system) using a higher frequency band (e.g. a frequency band of 6 GHz or above) than a frequency band (e.g. a frequency band of 6 GHz or below) of the long term evolution (LTE) communication system (or, LTE-A communication system) is being considered for processing of soaring wireless data. The NR system may support not only a frequency band of 6 GHz or below, but also a frequency band of 6 GHz or above, and may support various communication services and scenarios compared to the LTE system. In addition, requirements of the NR system may include enhanced Mobile BroadBand (eMBB), Ultra Reliable Low Latency Communication (URLLC), and Massive Machine Type Communication (mMTC).

A communication network (e.g. NR network) may be classified into a terrestrial network and a non-terrestrial network. The non-terrestrial network may be referred to as an NTN. In a terrestrial network, communication services for a terminal may be provided by a base station located on the ground. In a non-terrestrial network, communication services for a terminal may be provided by a communication node (e.g. satellite, base station, unmanned aerial vehicle (UAV), drone, or the like) located in a non-terrestrial location. Communication in the terrestrial network and the non-terrestrial network may be performed based on the NR communication technology.

Meanwhile, network optimization methods to improve communication performance in a communication network may be required. If a network optimization operation is performed using only specific parameters, optimization performance may deteriorate. In other words, when only specific parameters are used, characteristics in various communication environments cannot be reflected, and thus optimization performance may deteriorate. In particular, network optimization methods considering UAV characteristics may be required in a UAV-based communication network.

### SUMMARY

Exemplary embodiments of the present disclosure are directed to providing a method and an apparatus for optimization of communication performance in a UAV-based communication network.

According to a first exemplary embodiment of the present disclosure, a method of a first communication node may comprise: transmitting, to a second communication node, an initiation signal indicating to initiate a collection procedure of training data for a neural network; transmitting, to the second communication node, an information signal including network parameters of the first communication node; receiving, from the second communication node, the training data in response to the information signal; training the neural network using the training data; determining optimal network parameters using the trained neural network; and performing communication with the second communication node using the optimal network parameters.

The first communication node may be a terrestrial base station, and the second communication node may be a non-terrestrial terminal.

When a prediction accuracy of the neural network does not satisfy determination criteria, at least one of the initiation signal or the information signal may be transmitted to the second communication node.

When a prediction accuracy of the trained neural network satisfies determination criteria, a transmission periodicity of the initiation signal may increase, and when the prediction accuracy of the trained neural network does not satisfy the determination criteria, the transmission periodicity of the initiation signal may decrease.

The network parameters may include a distance between the first communication node and another communication node, a location of the first communication node, an antenna angle of the first communication node, a number of sectors of the first communication node, a beam set of the first communication node, or a beamforming vector of the first communication node, and the information signal may be a reference signal or a control signal.

The training data may include at least one of performance metrics for the network parameters, unmanned aerial vehicle (UAV) characteristic parameters, or environmental characteristic parameters, the UAV characteristic parameters are parameters indicating characteristics of the second communication node that is a UAV, and the environmental characteristic parameters are parameters that affect communication between the first communication node and the second communication node in addition to the network parameters and the UAV characteristic parameters.

The determining of the optimal network parameters may comprise: generating a signal quality map using the trained neural network when a prediction accuracy of the trained neural network satisfies determination criteria; and determining the optimal network parameters using the signal quality map.

An input of the trained neural network may include a distance between the first communication node and another communication node, an antenna angle of the first communication node, and an altitude of the second communication node, an output of the trained neural network may include a wideband signal to interference plus noise ratio (SINR), and the signal quality map may be a wideband SINR map.

According to a second exemplary embodiment of the present disclosure, a method of a first communication node may comprise: receiving, from a second communication node, an initiation signal indicating to initiate a collection procedure of training data of a neural network; in response to the initiation signal, transmitting, to the second communication node, an information signal including network parameters of the first communication node; receiving, from the second communication node, the training data in response to the information signal; training the neural network using the training data; determining optimal network parameters using the trained neural network; and performing communication with the second communication node using the optimal network parameters.

When a prediction accuracy of the trained neural network satisfies determination criteria, information on an increased transmission periodicity of the initiation signal may be transmitted to the second communication node, and when the prediction accuracy of the trained neural network does not satisfy the determination criteria, information on a decreased transmission periodicity of the initiation signal may be transmitted to the second communication node.

The network parameters may include a distance between the first communication node and another communication node, a location of the first communication node, an antenna angle of the first communication node, a number of sectors of the first communication node, a beam set of the first communication node, or a beamforming vector of the first communication node, and the information signal may be a reference signal or a control signal.

The training data may include at least one of performance metrics for the network parameters, unmanned aerial vehicle (UAV) characteristic parameters, or environmental characteristic parameters, the UAV characteristic parameters are parameters indicating characteristics of the second communication node that is a UAV, and the environmental characteristic parameters are parameters that affect communication between the first communication node and the second communication node in addition to the network parameters and the UAV characteristic parameters.

The determining of the optimal network parameters may comprise: generating a signal quality map using the trained neural network when a prediction accuracy of the trained neural network satisfies determination criteria; and determining the optimal network parameters using the signal quality map.

According to a third exemplary embodiment of the present disclosure, a method of a second communication node may comprise: transmitting, to a first communication node, an initiation signal indicating to initiate a collection procedure of training data for a neural network; in response to the initiation signal, receiving, from the first communication node, an information signal including network parameters of the first communication node; generating the training data based on the information signal; training the neural network using the training data; determining optimal network parameters using the trained neural network; and transmitting information on the optimal network parameters to the first communication terminal.

The first communication node may be a terrestrial base station, and the second communication node may be a non-terrestrial terminal.

When a prediction accuracy of the trained neural network satisfies determination criteria, a transmission periodicity of the initiation signal may increase, and when the prediction accuracy of the trained neural network does not satisfy the determination criteria, the transmission periodicity of the initiation signal may decrease.

The network parameters may include a distance between the first communication node and another communication node, a location of the first communication node, an antenna angle of the first communication node, a number of sectors of the first communication node, a beam set of the first communication node, or a beamforming vector of the first communication node, and the information signal may be a reference signal or a control signal.

The training data may include at least one of performance metrics for the network parameters, unmanned aerial vehicle (UAV) characteristic parameters, or environmental characteristic parameters, the UAV characteristic parameters are parameters indicating characteristics of the second communication node that is a UAV, and the environmental characteristic parameters are parameters that affect communication between the first communication node and the second communication node in addition to the network parameters and the UAV characteristic parameters.

The determining of the optimal network parameters may comprise: generating a signal quality map using the trained neural network when a prediction accuracy of the trained neural network satisfies determination criteria; and determining the optimal network parameters using the signal quality map.

An input of the trained neural network may include a distance between the first communication node and another communication node, an antenna angle of the first communication node, and an altitude of the second communication node, an output of the trained neural network may include a wideband signal to interference plus noise ratio (SINR), and the signal quality map may be a wideband SINR map.

A terrestrial communication network that supports terrestrial terminals may face challenges in providing communication services for non-terrestrial terminals, such as those at high altitudes. According to the present disclosure, the optimization of network parameters considers performance indicators related to network parameters, UAV characteristic parameters, and/or environmental characteristic parameters. In this context, optimizing various network parameters becomes feasible, taking into account the actual environmental conditions. The altitude (e.g. flight altitude), speed, channel environment, etc., of a non-terrestrial terminal (e.g. UAV) may vary, and signaling corresponding to the variation can be performed. In other words, adapting to environmental changes can be easily achieved. Furthermore, optimal network parameters can be determined and adjusted through a neural network, resulting in the maximization of communication performance.

### BRIEF DESCRIPTION OF DRAWINGS

FIG. 1 is a block diagram illustrating a first exemplary embodiment of a communication node in a communication network.

FIG. 2 is a conceptual diagram illustrating a first exemplary embodiment of a communication network.

FIG. 3 is a conceptual diagram illustrating a second exemplary embodiment of a communication network.

FIG. 4 is a conceptual diagram illustrating a third exemplary embodiment of a communication network.

FIG. 5 is a conceptual diagram illustrating input/output of a DNN for performance metric estimation.

FIG. 6 is a conceptual diagram illustrating input/output of a CNN for performance metric estimation.

FIG. 7 is a conceptual diagram illustrating input/output of an INR for performance metric estimation.

FIG. 8 is a conceptual diagram illustrating a method of utilizing a wideband SINR map within a cell according to an ISD and an uptilt angle of a base station for a specific altitude of a non-terrestrial terminal.

FIG. 9 is a conceptual diagram illustrating a method of utilizing a map to maximize an average wideband SINR within a cell for the entire altitudes of non-terrestrial nodes.

FIG. 10 is a flowchart illustrating an operation method of a base station when the base station is a training entity.

FIG. 11 is a flowchart illustrating a learning method when a base station is a training entity.

FIG. 12 is a sequence chart illustrating a first exemplary embodiment of a learning method when a non-terrestrial terminal is a training initiating entity.

FIG. 13 is a sequence chart illustrating a second exemplary embodiment of a learning method when a non-terrestrial terminal is a training initiating entity.

FIG. 14 is a flowchart illustrating a method of setting a transmission periodicity of an initiation signal for neural network training.

### DETAILED DESCRIPTION OF THE EMBODIMENTS

Exemplary embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e. “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system may be the 4G communication system (e.g. Long-Term Evolution (LTE) communication system or LTE-A communication system), the 5G communication system (e.g. New Radio (NR) communication system), the sixth generation (6G) communication system, or the like. The 4G communication system may support communications in a frequency band of 6 GHz or below, and the 5G communication system may support communications in a frequency band of 6 GHz or above as well as the frequency band of 6 GHz or below. The communication network may include a terrestrial network and a non-terrestrial network. The communication system to which the exemplary embodiments according to the present disclosure are applied is not limited to the contents described below, and the exemplary embodiments according to the present disclosure may be applied to various communication systems. Here, the communication system may be used in the same sense as a communication network, ‘LTE’ may refer to ‘4G communication system’, ‘LTE communication system’, or ‘LTE-A communication system’, and ‘NR’ may refer to ‘5G communication system’ or ‘NR communication system’.

In exemplary embodiments, “an operation (e.g. transmission operation) is configured” may mean that “configuration information (e.g. information element(s) or parameter(s)) for the operation and/or information indicating to perform the operation is signaled”. “Information element(s) (e.g. parameter(s)) are configured” may mean that “corresponding information element(s) are signaled”. In other words, “an operation (e.g. transmission operation) is configured in a communication node” may mean that the communication node receives “configuration information (e.g. information elements, parameters) for the operation” and/or “information indicating to perform the operation”. “An information element (e.g. parameter) is configured in a communication node” may mean that “the information element is signaled to the communication node (e.g. the communication node receives the information element)”.

The signaling may be at least one of system information (SI) signaling (e.g. transmission of system information block (SIB) and/or master information block (MIB)), RRC signaling (e.g. transmission of RRC parameters and/or higher layer parameters), MAC control element (CE) signaling, or PHY signaling (e.g. transmission of downlink control information (DCI), uplink control information (UCI), and/or sidelink control information (SCI)). A signaling message may be at least one of an SI signaling message (e.g. SI message), an RRC signaling message (e.g. RRC message), a MAC CE signaling message (e.g. MAC CE message or MAC message), or a PHY signaling message (e.g. PHY message).

Hereinafter, even when a method (e.g. transmission or reception of a signal) performed at a first communication node among communication nodes is described, a corresponding second communication node may perform a method (e.g. reception or transmission of the signal) corresponding to the method performed at the first communication node. That is, when an operation of a terminal is described, a base station corresponding to the terminal may perform an operation corresponding to the operation of the terminal. Conversely, when an operation of a base station is described, a terminal corresponding to the base station may perform an operation corresponding to the operation of the base station. In addition, when an operation of a first terminal is described, a second terminal corresponding to the first terminal may perform an operation corresponding to the operation of the first terminal. Conversely, when an operation of a second terminal is described, a first terminal corresponding to the second terminal may perform an operation corresponding to the operation of the second terminal.

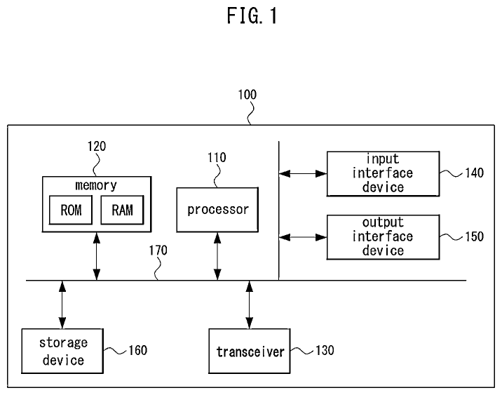

FIG. 1 is a block diagram illustrating a first exemplary embodiment of a communication node in a communication network.

Referring to FIG. 1, a communication node 100 may comprise at least one processor 110, a memory 120, and a transceiver 130 connected to the network for performing communications. Also, the communication node 100 may further comprise an input interface device 140, an output interface device 150, a storage device 160, and the like. Each component included in the communication node 100 may communicate with each other as connected through a bus 170.

However, each component included in the communication node 100 may not be connected to the common bus 170 but may be connected to the processor 110 via an individual interface or a separate bus. For example, the processor 110 may be connected to at least one of the memory 120, the transceiver 130, the input interface device 140, the output interface device 150 and the storage device 160 via a dedicated interface.

The processor 110 may execute a program stored in at least one of the memory 120 and the storage device 160. The processor 110 may refer to a central processing unit (CPU), a graphics processing unit (GPU), or a dedicated processor on which methods in accordance with embodiments of the present disclosure are performed. Each of the memory 120 and the storage device 160 may be constituted by at least one of a volatile storage medium and a non-volatile storage medium. For example, the memory 120 may comprise at least one of read-only memory (ROM) and random access memory (RAM).

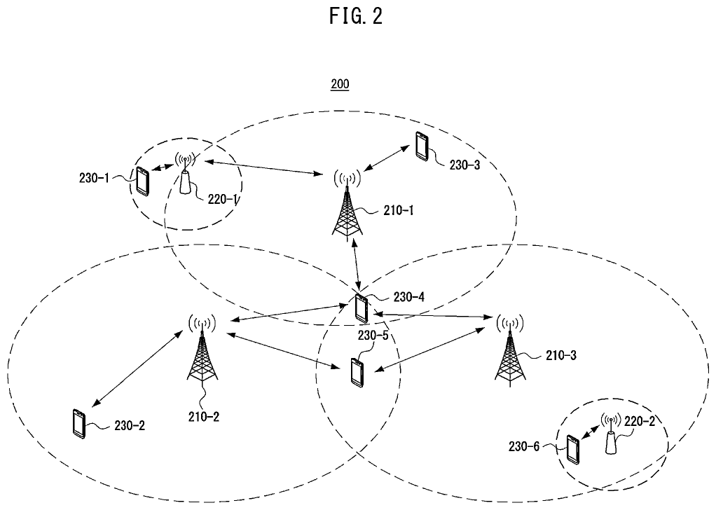

FIG. 2 is a conceptual diagram illustrating a first exemplary embodiment of a communication network.

Referring to FIG. 2, a communication network 200 may be a terrestrial network. The communication system 200 may comprise a plurality of communication nodes 210-1, 210-2, 210-3, 220-1, 220-2, 230-1, 230-2, 230-3, 230-4, 230-5, and 230-6. In addition, the communication system 200 may further comprise a core network (e.g. a serving gateway (S-GW), a packet data network (PDN) gateway (P-GW), and a mobility management entity (MME)). When the communication system 200 is a 5G communication system (e.g. new radio (NR) system), the core network may include an access and mobility management function (AMF), a user plane function (UPF), a session management function (SMF), and the like.

The plurality of communication nodes 210 to 230 may support a communication protocol defined by the 3rd generation partnership project (3GPP) specifications (e.g. LTE communication protocol, LTE-A communication protocol, NR communication protocol, or the like). The plurality of communication nodes 210 to 230 may support code division multiple access (CDMA) technology, wideband CDMA (WCDMA) technology, time division multiple access (TDMA) technology, frequency division multiple access (FDMA) technology, orthogonal frequency division multiplexing (OFDM) technology, filtered OFDM technology, cyclic prefix OFDM (CP-OFDM) technology, discrete Fourier transform-spread-OFDM (DFT-s-OFDM) technology, orthogonal frequency division multiple access (OFDMA) technology, single carrier FDMA (SC-FDMA) technology, non-orthogonal multiple access (NOMA) technology, generalized frequency division multiplexing (GFDM) technology, filter band multi-carrier (FBMC) technology, universal filtered multi-carrier (UFMC) technology, space division multiple access (SDMA) technology, or the like.

The communication system 200 may comprise a plurality of base stations 210-1, 210-2, 210-3, 220-1, and 220-2, and a plurality of terminals 230-1, 230-2, 230-3, 230-4, 230-5, and 230-6. Each of the first base station 210-1, the second base station 210-2, and the third base station 210-3 may form a macro cell, and each of the fourth base station 220-1 and the fifth base station 220-2 may form a small cell. The fourth base station 220-1, the third terminal 230-3, and the fourth terminal 230-4 may belong to cell coverage of the first base station 210-1. Also, the second terminal 230-2, the fourth terminal 230-4, and the fifth terminal 230-5 may belong to cell coverage of the second base station 210-2. Also, the fifth base station 220-2, the fourth terminal 230-4, the fifth terminal 230-5, and the sixth terminal 230-6 may belong to cell coverage of the third base station 210-3. Also, the first terminal 230-1 may belong to cell coverage of the fourth base station 220-1, and the sixth terminal 230-6 may belong to cell coverage of the fifth base station 220-2.

Here, each of the plurality of base stations 210-1, 210-2, 210-3, 220-1, and 220-2 may refer to a Node-B (NB), a evolved Node-B (eNB), a gNB, an advanced base station (ABS), a high reliability-base station (HR-BS), a base transceiver station (BTS), a radio base station, a radio transceiver, an access point, an access node, a radio access station (RAS), a mobile multihop relay-base station (MMR-BS), a relay station (RS), an advanced relay station (ARS), a high reliability-relay station (HR-RS), a home NodeB (HNB), a home eNodeB (HeNB), a road side unit (RSU), a radio remote head (RRH), a transmission point (TP), a transmission and reception point (TRP), or the like.

In the present disclosure, the base station may be a conventional base station (e.g. terrestrial base station) or a satellite base station. The base station may be interpreted as a terrestrial base station or a satellite base station depending on a context. The terrestrial base station may refer to a base station located on the ground. The satellite base station may refer to a base station located on a satellite (e.g. non-terrestrial base station). The satellite base station may be referred to as a non-terrestrial base station or a mobile base station. A satellite may be classified into a transparent satellite and a regenerative satellite. The transparent satellite may perform functions of a repeater for a base station. The regenerative satellite may perform functions of a base station. The satellite may be a low earth orbit (LEO) satellite, a medium earth orbit (MEO) satellite, or a geostationary equatorial orbit (GEO) satellite. Further, a high-altitude platform station system (HAPS) may be interpreted as a type of satellite. Additionally, a satellite may be interpreted as a type of unmanned aerial vehicle (UAV).

Each of the plurality of terminals 230-1, 230-2, 230-3, 230-4, 230-5, and 230-6 may refer to a user equipment (UE), a terminal equipment (TE), an advanced mobile station (AMS), a high reliability-mobile station (HR-MS), a terminal, an access terminal, a mobile terminal, a station, a subscriber station, a mobile station, a portable subscriber station, a node, a device, an on-board unit (OBU), or the like.

Each of the plurality of base stations 210-1, 210-2, 210-3, 220-1, and 220-2 may operate in the same frequency band or in different frequency bands. The plurality of base stations 210-1, 210-2, 210-3, 220-1, and 220-2 may be connected to each other via an ideal backhaul or a non-ideal backhaul, and exchange information with each other via the ideal or non-ideal backhaul. Also, each of the plurality of base stations 210-1, 210-2, 210-3, 220-1, and 220-2 may be connected to the core network through the ideal or non-ideal backhaul. Each of the plurality of base stations 210-1, 210-2, 210-3, 220-1, and 220-2 may transmit a signal received from the core network to the corresponding terminal 230-1, 230-2, 230-3, 230-4, 230-5, or 230-6, and transmit a signal received from the corresponding terminal 230-1, 230-2, 230-3, 230-4, 230-5, or 230-6 to the core network.

In addition, each of the plurality of base stations 210-1, 210-2, 210-3, 220-1, and 220-2 may support a multi-input multi-output (MIMO) transmission (e.g. a single-user MIMO (SU-MIMO), a multi-user MIMO (MU-MIMO), a massive MIMO, or the like), a coordinated multipoint (CoMP) transmission, a carrier aggregation (CA) transmission, a transmission in unlicensed band, device-to-device (D2D) communication (or, proximity services (ProSe)), Internet of Things (IoT) communications, dual connectivity (DC), or the like. Here, each of the plurality of terminals 230-1, 230-2, 230-3, 230-4, 230-5, and 230-6 may perform operations corresponding to the operations of the plurality of base stations 210-1, 210-2, 210-3, 220-1, and 220-2 (i.e. the operations supported by the plurality of base stations 210-1, 210-2, 210-3, 220-1, and 220-2). For example, the second base station 210-2 may transmit a signal to the fourth terminal 230-4 in the SU-MIMO manner, and the fourth terminal 230-4 may receive the signal from the second base station 210-2 in the SU-MIMO manner. Alternatively, the second base station 210-2 may transmit a signal to the fourth terminal 230-4 and fifth terminal 230-5 in the MU-MIMO manner, and the fourth terminal 230-4 and fifth terminal 230-5 may receive the signal from the second base station 210-2 in the MU-MIMO manner.

The first base station 210-1, the second base station 210-2, and the third base station 210-3 may transmit a signal to the fourth terminal 230-4 in the CoMP transmission manner, and the fourth terminal 230-4 may receive the signal from the first base station 210-1, the second base station 210-2, and the third base station 210-3 in the COMP manner. Also, each of the plurality of base stations 210-1, 210-2, 210-3, 220-1, and 220-2 may exchange signals with the corresponding terminals 230-1, 230-2, 230-3, 230-4, 230-5, or 230-6 which belongs to its cell coverage in the CA manner. Each of the base stations 210-1, 210-2, and 210-3 may control D2D communications between the fourth terminal 230-4 and the fifth terminal 230-5, and thus the fourth terminal 230-4 and the fifth terminal 230-5 may perform the D2D communications under control of the second base station 210-2 and the third base station 210-3.

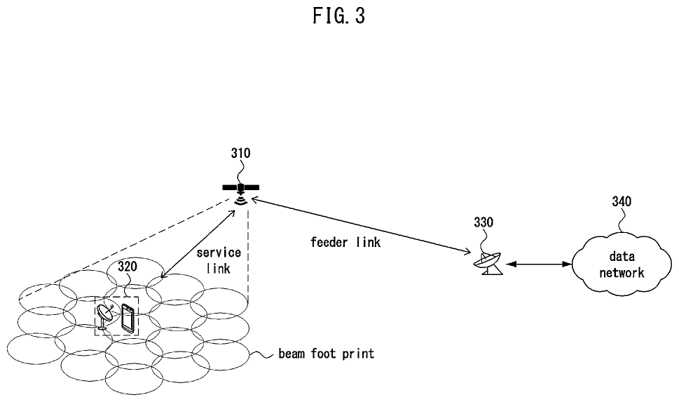

FIG. 3 is a conceptual diagram illustrating a second exemplary embodiment of a communication network.

Referring to FIG. 3, a communication network may be a non-terrestrial network (NTN). The NTN may include a satellite 310, a communication node 320, a gateway 330, a data network 340, and the like. The NTN shown in FIG. 3 may be an NTN based on a transparent payload. The satellite 310 may be a low earth orbit (LEO) satellite, a medium earth orbit (MEO) satellite, a geostationary earth orbit (GEO) satellite, a high elliptical orbit (HEO) satellite, or an unmanned aircraft system (UAS) platform. The UAS platform may include a high altitude platform station (HAPS).

The communication node 320 may include a communication node (e.g. a user equipment (UE) or a terminal) located on a terrestrial site and a communication node (e.g. an airplane, a drone) located on a non-terrestrial space. A service link may be established between the satellite 310 and the communication node 320, and the service link may be a radio link. The satellite 310 may provide communication services to the communication node 320 using one or more beams. The shape of a footprint of the beam of the satellite 310 may be elliptical.

The communication node 320 may perform communications (e.g. downlink communication and uplink communication) with the satellite 310 using LTE technology and/or NR technology. The communications between the satellite 310 and the communication node 320 may be performed using an NR-Uu interface. When dual connectivity (DC) is supported, the communication node 320 may be connected to other base stations (e.g. base stations supporting LTE and/or NR functionality) as well as the satellite 310, and perform DC operations based on the techniques defined in the LTE and/or NR specifications.

The gateway 330 may be located on a terrestrial site, and a feeder link may be established between the satellite 310 and the gateway 330. The feeder link may be a radio link. The gateway 330 may be referred to as a ‘non-terrestrial network (NTN) gateway’. The communications between the satellite 310 and the gateway 330 may be performed based on an NR-Uu interface or a satellite radio interface (SRI). The gateway 330 may be connected to the data network 340. There may be a ‘core network’ between the gateway 330 and the data network 340. In this case, the gateway 330 may be connected to the core network, and the core network may be connected to the data network 340. The core network may support the NR technology. For example, the core network may include an access and mobility management function (AMF), a user plane function (UPF), a session management function (SMF), and the like. The communications between the gateway 330 and the core network may be performed based on an NG-C/U interface.

Alternatively, a base station and the core network may exist between the gateway 330 and the data network 340. In this case, the gateway 330 may be connected with the base station, the base station may be connected with the core network, and the core network may be connected with the data network 340. The base station and core network may support the NR technology. The communications between the gateway 330 and the base station may be performed based on an NR-Uu interface, and the communications between the base station and the core network (e.g. AMF, UPF, SMF, and the like) may be performed based on an NG-C/U interface.

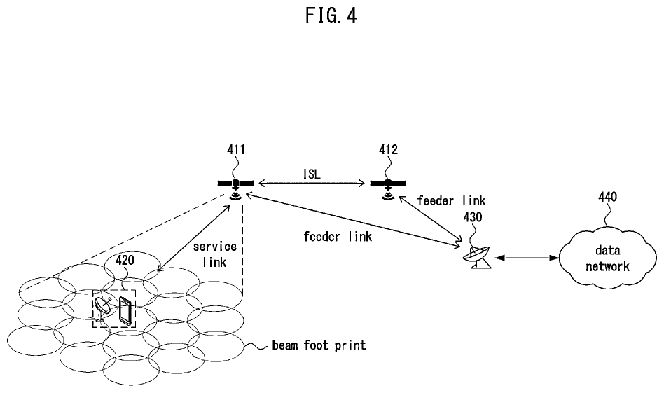

FIG. 4 is a conceptual diagram illustrating a third exemplary embodiment of a communication network.

Referring to FIG. 4, a communication network may be an NTN. The NTN may include a first satellite 411, a second satellite 412, a communication node 420, a gateway 430, a data network 440, and the like. The NTN shown in FIG. 4 may be a regenerative payload based NTN. For example, each of the satellites 411 and 412 may perform a regenerative operation (e.g. demodulation, decoding, re-encoding, re-modulation, and/or filtering operation) on a payload received from other entities (e.g. the communication node 420 or the gateway 430), and transmit the regenerated payload.

Each of the satellites 411 and 412 may be a LEO satellite, a MEO satellite, a GEO satellite, a HEO satellite, or a UAS platform. The UAS platform may include a HAPS. The satellite 411 may be connected to the satellite 412, and an inter-satellite link (ISL) may be established between the satellite 411 and the satellite 412. The ISL may operate in an RF frequency band or an optical band. The ISL may be established optionally. The communication node 420 may include a terrestrial communication node (e.g. UE or terminal) and a non-terrestrial communication node (e.g. airplane or drone). A service link (e.g. radio link) may be established between the satellite 411 and communication node 420. The satellite 411 may provide communication services to the communication node 420 using one or more beams.

The communication node 420 may perform communications (e.g. downlink communication or uplink communication) with the satellite 411 using LTE technology and/or NR technology. The communications between the satellite 411 and the communication node 420 may be performed using an NR-Uu interface. When DC is supported, the communication node 420 may be connected to other base stations (e.g. base stations supporting LTE and/or NR functionality) as well as the satellite 411, and may perform DC operations based on the techniques defined in the LTE and/or NR specifications.

The gateway 430 may be located on a terrestrial site, a feeder link may be established between the satellite 411 and the gateway 430, and a feeder link may be established between the satellite 412 and the gateway 430. The feeder link may be a radio link. When the ISL is not established between the satellite 411 and the satellite 412, the feeder link between the satellite 411 and the gateway 430 may be established mandatorily. The communications between each of the satellites 411 and 412 and the gateway 430 may be performed based on an NR-Uu interface or an SRI. The gateway 430 may be connected to the data network 440. There may be a core network between the gateway 430 and the data network 440. In this case, the gateway 430 may be connected to the core network, and the core network may be connected to the data network 440. The core network may support the NR technology. For example, the core network may include AMF, UPF, SMF, and the like. The communications between the gateway 430 and the core network may be performed based on an NG-C/U interface.

Alternatively, a base station and the core network may exist between the gateway 430 and the data network 440. In this case, the gateway 430 may be connected with the base station, the base station may be connected with the core network, and the core network may be connected with the data network 440. The base station and the core network may support the NR technology. The communications between the gateway 430 and the base station may be performed based on an NR-Uu interface, and the communications between the base station and the core network (e.g. AMF, UPF, SMF, and the like) may be performed based on an NG-C/U interface.

NTN reference scenarios may be defined as shown in Table 1 below.

TABLE 1

| | NTN shown | NTN shown |
|---|---|---|
| | in FIG. 1 | in FIG. 2 |
| GEO | Scenario A | Scenario B |
| LEO (steerable beams) | Scenario C1 | Scenario D1 |
| LEO (beams moving with satellite) | Scenario C2 | Scenario D2 |

When the satellite 310 in the NTN shown in FIG. 3 is a GEO satellite (e.g. a GEO satellite that supports a transparent function), this may be referred to as ‘scenario A’. When the satellites 411 and 412 in the NTN shown in FIG. 4 are GEO satellites (e.g. GEOs that support a regenerative function), this may be referred to as ‘scenario B’.

When the satellite 310 in the NTN shown in FIG. 3 is an LEO satellite with steerable beams, this may be referred to as ‘scenario C1’. When the satellite 310 in the NTN shown in FIG. 3 is an LEO satellite having beams moving with the satellite, this may be referred to as ‘scenario C2’. When the satellites 411 and 412 in the NTN shown in FIG. 4 are LEO satellites with steerable beams, this may be referred to as ‘scenario D1’. When the satellites 411 and 412 in the NTN shown in FIG. 4 are LEO satellites having beams moving with the satellites, this may be referred to as ‘scenario D2’.

Parameters for the scenarios defined in Table 1 may be defined as shown in Table 2 below.

TABLE 2

| | Scenarios A and B | | Scenarios C and D | |
|---|---|---|---|---|
| Altitude | 35,786 | km | 600 | km |
| | | | 1,200 | km |
| Spectrum (service link) | <6 GHz (e.g. 2 GHz) | | | |
| | >6 GHz (e.g. DL 20 GHz, UL 30 GHz) | | | |
| Maximum channel bandwidth | 30 MHz for band <6 GHz | | | |
| capability (service link) | 1 GHz for band >6 GHz | | | |
| Maximum distance between | 40,581 | km | 1,932 | km (altitude of 600 km) |
| satellite and communication | | | 3,131 | km (altitude of 1,200 km) |
| node (e.g. UE) at the | | | | |
| minimum elevation angle | | | | |
| Maximum round trip delay | Scenario A: 541.46 ms | | Scenario C: (transparent payload: | |
| (RTD) (only propagation | (service and feeder links) | | service and feeder links) | |
| delay) | Scenario B: 270.73 ms | | −5.77 | ms (altitude of 60 0 km) |
| | (only service link) | | −41.77 | ms (altitude of 1,200 km) |
| | | | Scenario D: (regenerative payload: | |
| | | | only service link) | |
| | | | −12.89 | ms (altitude of 600 km) |
| | | | −20.89 | ms (altitude of 1,200 km) |
| Maximum delay variation | 16 | ms | 4.44 | ms (altitude of 600 km) |
| within a single beam | | | 6.44 | ms (altitude of 1,200 km) |
| Maximum differential | 10.3 | ms | 3.12 | ms (altitude of 600 km) |
| delay within a cell | | | 3.18 | ms (altitude of 1,200 km) |

| | |
|---|---|
| Service link | NR defined in 3 GPP |
| Feeder link | Radio interfaces defined |
| | in 3 GPP or non-3 GPP |

In addition, in the scenarios defined in Table 1, delay constraints may be defined as shown in Table 3 below.

TABLE 3

| | | | Scenario | Scenario |
|---|---|---|---|---|
| | Scenario A | Scenario B | C1-2 | D1-2 |
| Satellite altitude | 35,786 km | | 600 km | |
| Maximum RTD in a | 541.75 ms | 270.57 ms | 28.41 ms | 12.88 ms |
| radio interface be- | (worst case) | | | |
| tween base station | | | | |
| and UE | | | | |
| Minimum RTD in a | 477.14 ms | 238.57 ms | 8 ms | 4 ms |
| radio interface be- | | | | |
| tween base station | | | | |
| and UE | | | | |

Meanwhile, network optimization methods to improve communication performance in a UAV-based communication network may be required. The characteristics of the UAV-based communication network (e.g. communication characteristics depending on mobility and/or altitudes of UAVs) may be distinct from those of a terrestrial communication network. The characteristics of the UAV-based communication network may change depending on the mobility and/or altitudes of UAVs, and methods for optimizing the network according to changes in the characteristics of the UAV-based communication network may be required. The UAV-based communication network may be optimized using a neural network. In the present disclosure, a UAV may be referred to as a non-terrestrial terminal. In the present disclosure, a base station may be interpreted as a terrestrial base station or a non-terrestrial base station depending on a context.

To improve communication performance in the UAV-based communication network, an uptilt angle of antenna(s) of a base station (e.g. terrestrial base station) may be mathematically optimized, and a deep neural network (DNN) may be used therefor. To improve communication performance in the UAV-based communication network, an inter-satellite distance (ISD), uptilt angle of the base station, number of sectors of the base station, and the like may be considered. The ISD may refer to a spacing between base stations.

When a network optimization operation is performed using only limited parameters (e.g. limited system parameters), the optimization performance of the UAV-based communication network may be degraded. When parameters subject to optimization in a mathematical modeling increase, it may be difficult to obtain optimal values through the mathematical modeling. It may be difficult to completely reflect the actual communication network in the mathematical modeling of a utilized channel, base station deployment, and the like.

An optimization operation for various parameters may be performed using a DNN. Even in this case, the characteristics of various communication environments, such as altitudes of UAVs and a distribution of UAVs by altitude, may not be reflected. Since the DNN has a limited neural network structure, network optimization performance may not be good when using the DNN. For neural network-based network optimization, reference signals (RSs) may be used, and methods for operating and signaling of RSs may be required.

Various parameters may be defined to optimize communication performance in the UAV-based communication network. For example, network parameters, UAV characteristic parameters, and/or environmental characteristic parameters may be defined. The network parameters may be network configuration parameters. The network parameters may include at least one of a spacing between base stations (e.g. ISD), location(s) of base station(s), angle (e.g. uptilt angle) of antennas(s) (e.g. antenna panel(s))) of base station(s), number of sectors of each base station, beam set of each base station, or beamforming vectors of each base station. The UAV characteristic parameters may be parameter(s) representing characteristics of UAV. The UAV characteristic parameter may include at least one of the altitude of each UAV (e.g. non-terrestrial terminal), distribution of UAVs by altitude, or movement speed of each UAV. The environmental characteristic parameters may be parameter(s) that affect communication in addition to the network parameters and the UAV characteristic parameters. The environmental characteristic parameters may include at least one of the number of antennas of each UAV (e.g. non-terrestrial terminal) or the number of antennas of each base station (e.g. terrestrial base station).

The performance metrics (e.g. performance metrics for the UAV-based communication network) may indicate communication performances influenced by the parameters (e.g. network parameters, UAV characteristic parameters, and/or environmental characteristic parameters). For example, the performance metrics may include at least one of a wideband signal to noise plus interference ratio (SINR), latency, effective SINR, throughput, coverage, outage probability, or spectral efficiency. The wideband SINR (e.g. SINR) may refer to a signal quality. An objective function (or loss function) may be a final performance target desired to be maximized or minimized. The objective function may be determined according to the performance metrics. For example, the final performance target may be an average wideband SINR of UAV(s) within a cell, and/or the like.

[Configuration of Input and/or Output of a Neural Network, and Training Method of the Neural Network]

For optimization of a UAV-based communication network, optimal parameters (e.g. optimal network parameters) that maximize or minimize the objective function may be determined. The performance metrics (e.g. communication performance metrics) that are variables of the objective function may be determined by network parameters, UAV characteristic parameters, and/or environmental characteristic parameters. The communication performance may be affected by various random variables in addition to the above-described parameters (e.g. network parameters, UAV characteristic parameters, and/or environmental characteristic parameters). In the UAV-based communication network, the UAV characteristic parameters may be additionally considered. When the UAV characteristic parameters are additionally considered, the mathematical solution may be difficult.

Due to the above-described problem, a method of determining optimal parameters (e.g. optimal network parameters) through collection of data (e.g. training data) may be considered. However, when non-terrestrial terminals (e.g. UAVs) are utilized, the number of parameters that need to be considered for network optimization may increase, and accordingly, it may be not easy to obtain sufficient data for all parameter candidate groups (e.g. candidate groups for parameter values). Therefore, observed and/or collected in some environments data may be utilized.

When a neural network is used, the performance metric values of the candidate group for the parameter values considered for network optimization may be obtained through a regression analysis scheme, interpolation scheme, etc. performed on limited data. When a neural network is used, the performance metric values of the candidate group for the parameter values considered for network optimization may be estimated, and optimal parameters (e.g. optimal network parameters) maximizing or minimizing the objective function may be obtained based on the estimated performance metric values. For example, a performance metric map with the parameter candidate groups (e.g. candidate groups for parameter values) as axes may be generated (e.g. configured) using the neural network. By utilizing the structure of the performance metric map, optimal parameters (e.g. optimal network parameters) that maximize or minimize the objective function may be obtained.

The neural network may utilize limited data to train the performance metrics for the network parameters, UAV characteristic parameters, and/or environmental characteristic parameters. The data for training the performance metrics may be actual measurement data (i.e. ground-truth data) that can be measured in an LTE communication network, NR communication network, non-terrestrial communication network, and/or terrestrial communication network. In addition, the data for training the performance metrics may be actual measurement data obtained through operations of an LTE communication network, NR communication network, non-terrestrial communication network, and/or terrestrial communication network. When it is difficult to secure actual measurement data, simulations such as system-level simulation (SLS) may be used. The input and output of the neural network may vary depending on the structure of the neural network. Each of the inputs and outputs of the neural network may be one of network parameters, UAV characteristic parameters, environmental characteristic parameters, performance metrics (e.g. performance metric values), and/or data including information of the parameters.

A plurality of neural networks may be used depending on the network parameters to be optimized, the UAV characteristic parameters considered for network optimization, and/or the environmental characteristic parameters considered for network optimization. The neural network may be a convolutional neural network (CNN), generative adversarial networks (GAN), and/or variational auto encoder (VAE). The CNN may be a DNN, a recurrent neural network (RNN), a long-short term memory (LSTM), a deep Q-network, a super resolution CNN (SRCNN), and/or an implicit neural network (INR). Alternatively, other neural networks (e.g. neural network structures) other than the neural networks described above may be used. The dimension, normalization scheme, etc. of the input and/or output of the neural network may vary depending on the neural network used.

The performance metrics (e.g. performance metric values) for the candidate groups of network parameters, UAV characteristic parameters, and/or environmental characteristic parameters may be estimated using a trained neural network. Optimization of the objective function may be possible using the neural network. For example, a performance requirement map (e.g. performance metric map) with the network parameters, UAV characteristic parameters, and/or environmental characteristic parameters as axes may be generated utilizing the neural network. Optimal parameters (e.g. optimal network parameters) may be obtained using the performance requirement map according to the objective function desired to be maximized or minimized. A form of the performance requirement map may vary. Depending on the objective function to optimize, the method of using the performance requirement map may vary.

Based on the above-described method, it may be possible to optimize parameters for the UAV-based communication network as well as parameters for a communication network in which UAVs and terrestrial terminals coexist. The UAV may refer to an aerial terminal, a non-terrestrial terminal, or the like.

### [Training and Operation Method of Neural Network]

When actual measurement data is secured, it may be necessary to secure performance metric values (e.g. observed values of performance metrics) for various parameters in order to construct a neural network. The base station (e.g. terrestrial base station) may transmit, to a non-terrestrial node (e.g. UAV) having various UAV characteristic parameters and/or various environmental characteristic parameters, a signal for observation of the performance metrics (e.g. signal including information on network parameters) while changing network parameters. The signal (e.g. information signal) including information on network parameters may be referred to as a network parameter information signal (NPS). The non-terrestrial node may receive the NPS from the base station and collect (e.g. obtain) performance metric values based on the NPS. The NPS may be a reference signal and/or a control signal. Alternatively, the NPS may be the network parameter themselves. The reference signal may be a channel state information-reference signal (CSI-RS), a sounding reference signal (SRS), a synchronization signal block (SSB), and/or a cell specific reference signal (CRS).

The operation of transmitting the NPS and/or the operation of obtaining performance metric values based on the NPS may vary depending on an entity that determines initiation of data collection for neural network training (e.g. obtaining of performance metric values). For example, the entity that determines initiation of data collection for neural network training (e.g. training initiating entity) may be the base station or non-terrestrial terminal. The initiation of data collection for neural network training may be performed through transmission and reception of an initiation signal (e.g. start flag or initiation flag). The initiation signal may be a radio resource control (RRC) reconfiguration message, layer 1 (L1) signal, downlink control information (DCI), medium access control (MAC) control element (CE), and/or random access channel (RACH) message.

A. When an Entity that Determines Initiation of Data Collection for Neural Network Training (e.g. Training Initiating Entity) is a Base Station

The base station may identify scheduling information for a non-terrestrial terminal in an RRC idle state or a non-terrestrial terminal in an RRC connected state (e.g. partial RRC connected state), and transmit an initiation signal for securing training data to the non-terrestrial terminal based on the identified scheduling information. The non-terrestrial terminal may receive the initiation signal from the base station and may initiate a collection operation of training data (e.g. data for neural network training) based on the initiation signal. When it is important to secure training data, the base station may utilize additional RSs. The base station may transmit the initiation signal periodically or aperiodically. After transmitting the initiation signal, the base station may transmit the NPS while changing network parameters.

B. When an Entity that Determines Initiation of Data Collection for Neural Network Training (e.g. Training Initiating Entity) is a Non-Terrestrial Terminal

If there are sufficient resources allocatable for collection of training data, the non-terrestrial terminal may transmit an initiation signal for securing training data to the base station. Alternatively, regardless of allocatable resources, the non-terrestrial terminal may transmit the initiation signal for securing training data to the base station. The non-terrestrial terminal may transmit the initiation signal periodically or aperiodically. The base station may receive the initiation signal from the non-terrestrial terminal, determine a training period (e.g. training period of the neural network) based on the initiation signal, and transmit the NPS according to the training period while changing network parameters.

Depending on a training entity of the neural network, the following operations may be considered.

### A. When a Training Entity of the Neural Network is a Base Station

The non-terrestrial terminal may collect training data. For example, the non-terrestrial terminal may collect training data based on the NPS received from the base station. The non-terrestrial terminal may transmit the training data to the base station. The base station may receive the training data from the non-terrestrial terminal and may perform training of the neural network based on the training data. For example, the training of the neural network may be performed in a scheme of federated learning.

### B. When a Training Entity of the Neural Network is a Non-Terrestrial Terminal

The non-terrestrial terminal may collect training data. For example, the non-terrestrial terminal may collect training data based on the NPS received from the base station. The non-terrestrial terminal may train the neural network based on the training data. The training of the neural network may be performed by upper layer(s).

In the training procedure of the neural network, the training entity may change. For example, the training entity of the neural network may change from the base station to the non-terrestrial terminal. Alternatively, the training entity of the neural network may change from the non-terrestrial terminal to the base station. The utilized neural network parameters (e.g. structure, weights, etc.) and/or the training procedure of the neural network may be shared/exchanged between communication nodes. A transfer learning may be performed based on the shared neural network parameters and/or shared training procedure. The communication nodes may be the base station and/or non-terrestrial terminal. The objective of transfer learning may be to improve performance in a target domain by transferring knowledge included in related domains and/or other domains. A learning time required for the transfer learning may be shorter than a learning time required for re-training a neural network after transferring a structure and weights of an already trained neural network (e.g. method of training the neural network again from the beginning). The transfer learning may have high accuracy, and according to the transfer learning, a neural network suitable for a new model can be trained efficiently. Therefore, responses to environmental changes can be carried out quickly.

Criteria for determining a prediction accuracy of the neural network being trained may be as follows.

### A. Criteria for Determining a Prediction Accuracy and Utilizing Training Data

Depending on an entity of neural network training, the base station or non-terrestrial terminal may verify whether the trained neural network has sufficient prediction accuracy. The training entity (e.g. base station or non-terrestrial terminal) may verify the prediction accuracy by comparing a predicted value of the trained neural network with the training data. The training entity may verify the prediction accuracy by comparing a predicted value for an environment for which training data is not secured and the training data. A mean square error (MSE), cross entropy error (CEE), etc. may be used as a comparison scheme between the predicted value and the data (e.g. training data).

When the prediction accuracy satisfies the determination criteria or when the prediction accuracy satisfies the determination criteria and the number of transmissions or receptions of the initiation signal is more than a reference number, data of the neural network (e.g. trained neural network) may be utilized. Depending on the method of utilizing RSs, a transmission periodicity of the NPS may be changed if the training entity determines the suitability of the neural network. For example, if the prediction accuracy of the neural network satisfies the determination criteria, the transmission periodicity of the NPS may increase, and if the prediction accuracy of the neural network does not satisfy the determination criteria, the transmission periodicity of the NPS may decrease. The base station and/or non-terrestrial terminal may perform downlink (DL) scheduling (e.g. scheduling of DL subframes) and/or uplink (UL) scheduling (e.g. scheduling of UL subframes) in consideration of the degree of training of the neural network.

If the prediction accuracy of the neural network does not satisfy the determination criteria, at least one of use of the network parameters of the NR communication network (e.g. use of the existing network parameters), maintaining of the current settings of the parameters, utilization of swept network parameters, or use of outputs of the neural network may be performed.

### B. Criteria for a Determination Periodicity of Prediction Accuracy and a Transmission Periodicity of Initiation Signal

The determination of the neural network's prediction accuracy may be performed on a regular or periodic basis. When the determination of the prediction accuracy of the neural network is performed on a regular basis, an entity (e.g. base station or non-terrestrial terminal) that determines the prediction accuracy of the neural network may determine the prediction accuracy of the neural network for each NPS transmission. When the determination of the neural network's prediction accuracy is performed periodically, the determination periodicity of the neural network's prediction accuracy may be referred to as a network optimizing time (NOT). The NOT may be changed. The prediction accuracy of the neural network may not be determined during a NOT.

When additional RS(s) for the initiation signal are utilized, the determining entity may reduce the overhead due to NPS transmission by changing the transmission periodicity of the initiation signal. Additionally, the determining entity may respond to changes in the UAV environment by changing the transmission periodicity of the initiation signal. When the transmission periodicity of the initiation signal increases, the error in the prediction accuracy of the neural network may be within a certain range, and the number of transmissions of the NPS including the reference signal and/or control signal may be more than a threshold. When the above-described condition(s) are satisfied and the determining entity and the training entity are the same, the transmission periodicity of the initiation signal may be increased. When the above-described condition(s) are satisfied and the determining entity and the training entity are different, the training entity may transmit a latency indicator (LI) to the determining entity to request an increase in the transmission periodicity of the initiation signal. In other words, the value of LI may request an increase in the transmission periodicity of the initiation signal.

When the error in the prediction accuracy of the neural network increases due to changes in the UAV environment, and the determining entity and the training entity are the same, the transmission periodicity of the initiation signal may be reduced. When the error in the prediction accuracy of the neural network increases due to changes in the UAV environment, and the determining entity and the training entity are different, the training entity may transmit an LI to the determining entity to request a reduction in the transmission periodicity of the initiation signal. In other words, the value of LI may request a reduction in the transmission periodicity of the initiation signal. Through the above-described operation, responses to changes in the UAV characteristic parameters can be performed.

### Exemplary Embodiments of Neural Network

[Input Parameters and/or Output Parameters of Neural Network]

The network parameters may include the ISD (e.g. spacing between base stations), uptilt angle of the base station's antenna, and the like. The UAV characteristic parameters may include the altitude of the non-terrestrial terminal (e.g. UAV), and the like. The performance metrics may include the wideband SINR (e.g. SINR), and the like. The objective of the objective function may be to maximize the average wideband SINR of the non-terrestrial terminal or to maximize the minimum wideband SINR of the non-terrestrial terminal. Depending on the structure of the neural network, the structure of input and/or output may vary. In this case, the following preprocessing results may be used as input and/or output of the neural network.

### A. Normalization

A unit for the ISD or the altitude of the non-terrestrial terminal (e.g. UAV), which is an input parameter of the neural network, may be meter (m) or kilometer (km). A unit for the antenna angle of the base station (e.g. uptilt angle of the antenna), which is an input parameter of the neural network, may be degrees or radians. A unit for the wideband SINR, which is an output parameter of the neural network, may be dB.

When a distribution and/or size of data (e.g. training data) is different, weight update may be biased toward features with larger unit values. In this case, training of the neural network may not be performed properly. Therefore, a normalization entity (e.g. base station or non-terrestrial terminal) may make the distribution and/or size of data (e.g. training data) the same by performing a normalization operation. By the normalization operation, the training performance of the neural network can be improved. The normalization entity may be the training entity or an entity that transmits the training data.

### B. Neural Network Input and Output, Neural Network Training Scheme

i) Training through DNN

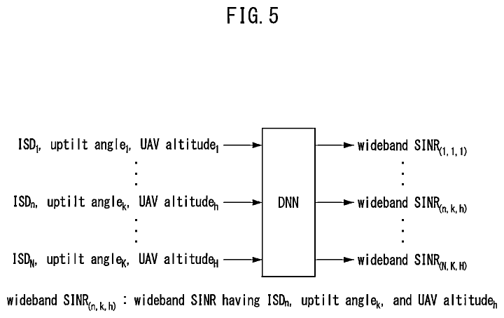

FIG. 5 is a conceptual diagram illustrating input/output of a DNN for performance metric estimation.

Referring to FIG. 5, when a DNN is utilized, the ISD (e.g. spacing between base stations), the antenna angle of the base station (e.g. uptilt angle of the antenna), and the altitude of the non-terrestrial terminal (e.g. UAV altitude) may be input to the DNN, and the output of the DNN may be the wideband SINR. The communication nodes (e.g. base station, non-terrestrial terminal, training initiating entity, training entity, determining entity, and normalization entity) may estimate the wideband SINR for data that has not been acquired (e.g. training data), such as the ISD, the uptilt angle of the base station, and the altitude of the non-terrestrial terminal, by using the trained DNN. For example, the communication node may estimate the wideband SINR for the ISD, the uptilt angle of the base station, and the altitude of the non-terrestrial terminal by performing regression analysis utilizing the trained DNN.

ii) Training through CNN

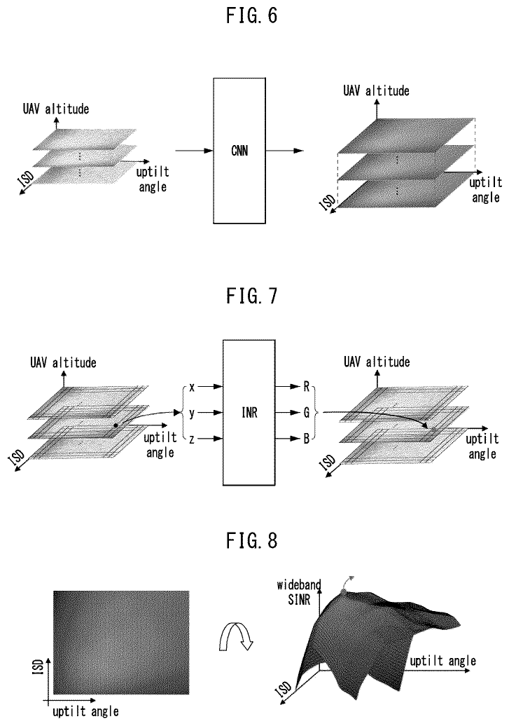

FIG. 6 is a conceptual diagram illustrating input/output of a CNN for performance metric estimation.

Referring to FIG. 6, when a CNN is utilized, an image of the wideband SINR for the ISD (e.g. spacing between base stations), the antenna angle of the base station (e.g. uptilt angle of the antenna), and the altitude of the non-terrestrial terminal (e.g. UAV altitude) may be input to the CNN. For example, the x-axis input of the CNN may be a low-resolution image of a wideband SINR map for the uptilt angle of the base station, the y-axis input of the CNN may be a low-resolution image of a wideband SINR map for the ISD, and the z-axis input of the CNN of may be a low-resolution image of a wideband SINR map for the altitude of the non-terrestrial terminal. When the CNN is utilized, data on a candidate group for entire values may be required for supervised learning. It may be possible to estimate performance metrics for an environment with limited data using the trained CNN. According to the above-described method, wideband SINR maps for the candidate groups of the ISD, uptilt angle of the base station, and altitude of non-terrestrial terminal may be obtained. The wideband SINR map may refer to a signal quality map.

iii) Training through INR

FIG. 7 is a conceptual diagram illustrating input/output of an INR for performance metric estimation.

Referring to FIG. 7, when an INR is utilized, an image of the wideband SINR for the ISD, the antenna angle of the base station (e.g. uptilt angle), and the altitude of the non-terrestrial terminal (e.g. UAV altitude) may be input to the INR. For example, the x-axis input of the INR may be a low-resolution image of a wideband SINR map for the base station's uptilt angle, the y-axis input of the INR may be a low-resolution image of a wideband SINR map for the ISD, and the z-axis input of the INR may be a low-resolution image of a wideband SINR map of the non-terrestrial terminal's altitude. The INR may perform supervised learning on RGB values of coordinates (x, y, z) of the low-resolution 3D image. Since a high-resolution image is not required, it may be possible to estimate the wideband SINR by reflecting the correlation with respect to the ISD, uptilt angle of the base station, and altitude of the non-terrestrial terminal with only limited data. The communication nodes (e.g. base station, non-terrestrial terminal, training initiating entity, training entity, determining entity, normalization entity) may utilize the trained INR to estimate the wideband SINRs, which are high-resolution RGB values for the coordinates (base station's uptilt angle, ISD, non-terrestrial terminal's altitude).

When the neural network architectures described above are used, the communication node may predict high resolution values based on low resolution values for the entire range of network parameters. In addition to the above-described neural network structures, a neural network that learns at a high resolution only for a region with a high wideband SINR may be used. For example, a multiscale INR (MINER) neural network may be utilized. The MINER may be a neural network algorithm that adaptively determines a window size. When the MINER is utilized, high accuracy can be achieved with fewer parameters, less memory, and/or less computation.

### C. Method of Map Utilization

FIG. 8 is a conceptual diagram illustrating a method of utilizing a wideband SINR map within a cell according to an ISD and an uptilt angle of a base station for a specific altitude of a non-terrestrial terminal.

Referring to FIG. 8, the communication node may utilize the trained neural network to obtain a high-resolution performance metric map with the base station's uptilt angle, ISD, and non-terrestrial terminal's altitude (e.g. UAV altitude) as respective axes. The communication node may obtain optimal network parameter(s) that maximizes the objective by utilizing the performance metric map.

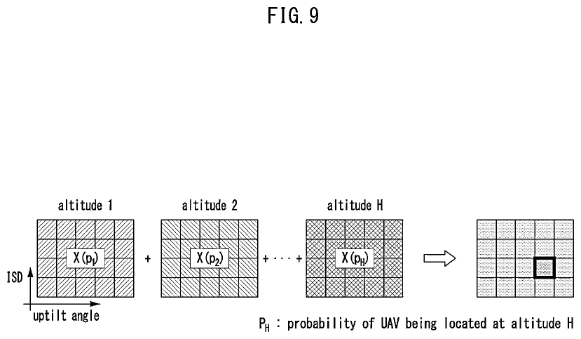

FIG. 9 is a conceptual diagram illustrating a method of utilizing a map to maximize an average wideband SINR within a cell for the entire altitudes of non-terrestrial nodes.

Referring to FIG. 9, when non-terrestrial nodes (e.g. UAVs) are distributed at various altitudes, one example of an objective function may be maximization of the average SINR (e.g. average wideband SINR) of the non-terrestrial nodes within a cell. In order to maximize the average wideband SINR of the non-terrestrial nodes, the communication node may multiply a map (e.g. wideband SINR map) with a distribution probability of the non-terrestrial nodes by altitude, and obtain an average wideband SINR map within the cell for the entire altitudes by summing maps that respectively reflect the distribution probability of the non-terrestrial nodes by altitude. The communication node may determine an ISD and uptilt angle of the base station that yield the maximum wideband SINR performance as optimal network parameters based on the average wideband SINR map within the cell for the entire altitudes.

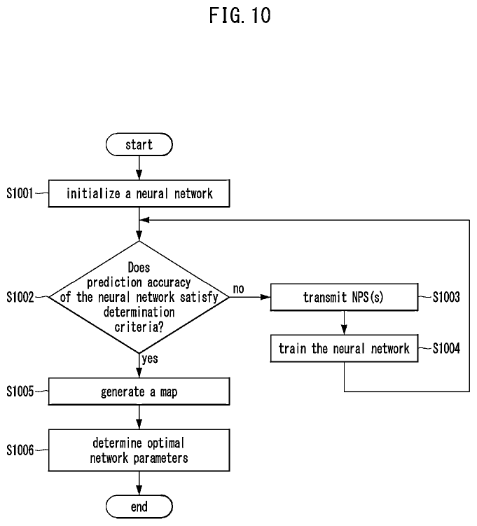

FIG. 10 is a flowchart illustrating an operation method of a base station when the base station is a training entity.

Referring to FIG. 10, operations of FIG. 10 may be performed after an initiation signal for initiating data collection for neural network training is transmitted. The initiation signal may be a signal for initiating neural network training. The transmission operation of the initiation signal may be performed before transmission of NPS(s). The initiation signal may be transmitted by a base station or a non-terrestrial terminal (e.g. UAV). The base station may initialize the neural network (S1001). The base station may determine whether a prediction accuracy of the initialized neural network satisfies determination criteria (S1002). If the prediction accuracy of the initialized neural network satisfies the determination criteria, the base station may generate a map (e.g. wideband SINR map, SINR map, signal quality map) using the initialized neural network (S1005).

If the prediction accuracy of the initialized neural network does not meet the determination criteria, the base station may transmit NPS(s) for training of the neural network (S1003). The NPS may be transmitted to one or more non-terrestrial terminals. The one or more non-terrestrial terminals may receive the NPS from the base station, generate training data (e.g. performance metrics, UAV characteristic parameters, environmental characteristic parameters) based on the NPS, and transmit the training data to the base station. The base station may receive the training data from the one or more non-terrestrial terminals and perform training of the neural network using the training data (S1004).

The base station may determine whether the prediction accuracy of the trained neural network satisfies the determination criteria (S1002). If the prediction accuracy of the trained neural network satisfies the determination criteria, the base station may generate a map (e.g. wideband SINR map, SINR map, signal quality map) using the trained neural network (S1005). If the prediction accuracy of the trained neural network does not meet the determination criteria, the base station may perform the steps S1003 and S1004 again. The steps S1003 and S1004 may be repeatedly performed until the prediction accuracy of the trained neural network satisfies the determination criteria. In other words, to improve the prediction accuracy of the trained neural network, the steps S1003 and S1004 may be performed repeatedly.

When the map is generated in the step S1005, the base station may use the map to determine optimal network parameters (S1006). The base station may perform communication with the non-terrestrial nodes using the optimal network parameters.

Although the operations in FIG. 10 have been described as being performed at the base station, if the training entity is a non-terrestrial node, the non-terrestrial node may perform the operations in FIG. 10. In other words, the non-terrestrial node may determine optimal network parameters by performing the steps S1001 to S1006, transmit information on the optimal network parameters to the base station, and perform communication with the base station based on the optimal network parameters.

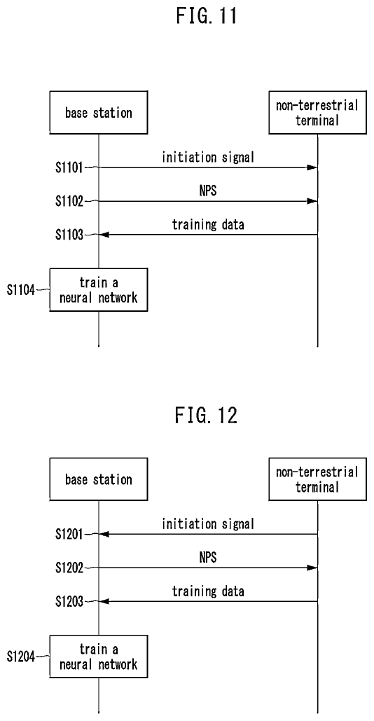

FIG. 11 is a flowchart illustrating a learning method when a base station is a training entity.

Referring to FIG. 11, a base station (e.g. terrestrial base station) may be an entity of initiating training (hereinafter referred to as ‘training initiating entity’) and a training entity. Additionally, the base station may be a determining entity. The operations of FIG. 11 may be performed to search for a beam set. The operations of FIG. 11 may be performed when it is determined that the prediction accuracy of the neural network (e.g. initialized neural network or trained neural network) does not satisfy the determined criteria in the step S1002 of FIG. 10. Alternatively, the operations of FIG. 11 may be performed regardless of the prediction accuracy of the neural network.

The base station may transmit an initiation signal to initiate data collection for neural network training to non-terrestrial terminal(s) (S1101). The initiation signal may be a signal for initiating neural network training. The non-terrestrial terminal(s) may receive the initiation signal from the base station. When the initiation signal is received, the non-terrestrial terminal(s) may determine that a training procedure of the neural network and/or a collection procedure of data (e.g. training data) for training the neural network is initiated.

After transmitting the initiation signal, the base station may transmit NPS(s) to the non-terrestrial terminal(s) (S1102). The NPS may be a signal (e.g. information signal) including information on network parameters of the base station. The non-terrestrial terminal(s) may receive the NPS from the base station and identify the information on the network parameters of the base station included in the NPS. The non-terrestrial terminal(s) may generate training data based on the NPS. The training data may include performance metrics (e.g. received signal strength (RSS), SINR, etc.), UAV characteristic parameters, and/or environmental characteristic parameters. The performance metrics, UAV characteristic parameters, and/or environmental characteristic parameters may be associated with the network parameters indicated by the NPS. The non-terrestrial terminal(s) may transmit the training data to the base station (S1103).

The base station may receive the training data from non-terrestrial terminal(s) and may train the neural network using the training data (S1104). The base station may use the trained neural network to predict performance metrics for the NPS and/or UAV characteristic parameters. The base station may generate an n-th map with beamforming vectors and/or UAV characteristic parameters as axes based on a prediction result of the trained neural network. By utilizing the trained neural network, the base station may perform regression analysis operations and/or interpolation operations on (some) network parameters and (some) UAV characteristic parameters, and based on a result of the regression analysis operations and/or interpolation operations, the base station may generate a high-resolution map and utilize the high-resolution map to optimize a beam set suitable for the UAV characteristics and/or environmental characteristics.

If the prediction accuracy of the neural network satisfies the determination criteria, the base station may update the optimal network parameters obtained using the neural network. A period and/or termination criterion of the training procedure of the neural network may be configured in various ways. When a comparison result between predicted data of the neural network and actual measurement data satisfies a reference MSE, when the number of transmissions of the reference signal (e.g. NPS) is greater than a reference number, and/or when a period of the training procedure of the neural network ends, the base station may terminate the training of the neural network.

FIG. 12 is a sequence chart illustrating a first exemplary embodiment of a learning method when a non-terrestrial terminal is a training initiating entity.

Referring to FIG. 12, a non-terrestrial terminal may be a training initiating entity of a neural network, and a base station (e.g. terrestrial base station) may be a training entity of the neural network. The non-terrestrial terminal may transmit an initiation signal to the base station to initiate data collection for neural network training (S1201). The initiation signal may be a signal for initiating neural network training. The base station may receive the initiation signal from the non-terrestrial terminal. When the initiation signal is received, the base station may determine that a training procedure of the neural network and/or a collection procedure of data (e.g. training data) for training the neural network is initiated.

After receiving the initiation signal, the base station may transmit NPS(s) to the non-terrestrial terminal (S1202). The NPS may be a signal (e.g. information signal) including information on network parameters of the base station. The non-terrestrial terminal may receive the NPS from the base station and identify information on the network parameters of the base station included in the NPS. The non-terrestrial terminal may generate training data based on the NPS. The training data may include performance metrics (e.g. RSS, SINR, etc.), UAV characteristic parameters, and/or environmental characteristic parameters. The performance metrics, UAV characteristic parameters, and/or environmental characteristic parameters may be associated with the network parameters indicated by the NPS. The non-terrestrial terminal may transmit the training data to the base station (S1203). The base station may receive the training data from the non-terrestrial terminal and train the neural network using the training data (S1204). The base station may determine optimal network parameters using the trained neural network, and may perform communication with the non-terrestrial terminal using the optimal network parameters.

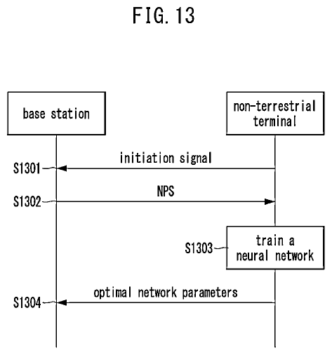

FIG. 13 is a sequence chart illustrating a second exemplary embodiment of a learning method when a non-terrestrial terminal is a training initiating entity.

Referring to FIG. 13, a non-terrestrial terminal may be a training initiating entity of a neural network and a training entity of the neural network. The non-terrestrial terminal may transmit an initiation signal to a base station (e.g. terrestrial base station) to initiate data collection for neural network training (S1301). The initiation signal may be a signal for initiating neural network training. The base station may receive the initiation signal from the non-terrestrial terminal. When the initiation signal is received, the base station may determine that a training procedure of the neural network and/or a collection procedure of data (e.g. training data) for training the neural network is initiated.

After receiving the initiation signal, the base station may transmit NPS(s) to the non-terrestrial terminal (S1302). The NPS may be a signal (e.g. information signal) including information on network parameters of the base station. The non-terrestrial terminal may receive the NPS from the base station and identify information on the network parameters of the base station included in the NPS. The non-terrestrial terminal may generate training data based on the NPS. The training data may include performance metrics (e.g. RSS, SINR, etc.), UAV characteristic parameters, and/or environmental characteristic parameters. The performance metrics, UAV characteristic parameters, and/or environmental characteristic parameters may be associated with the network parameters indicated by the NPS. The non-terrestrial terminal may train the neural network using the training data (S1303). The non-terrestrial terminal may determine optimal network parameters using the trained neural network. The non-terrestrial terminal may transmit a signal (e.g. NPS) including information on the optimal network parameters to the base station (S1304). The base station may receive information on the optimal network parameters from the non-terrestrial terminal and may perform communication with the non-terrestrial terminal using the optimal network parameters.

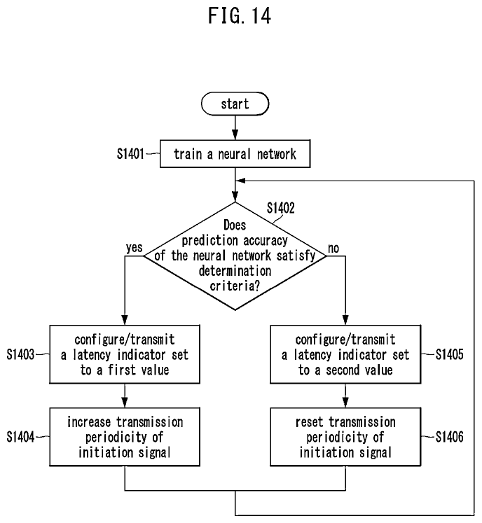

FIG. 14 is a flowchart illustrating a method of setting a transmission periodicity of an initiation signal for neural network training.

Referring to FIG. 14, a base station may utilize a neural network to optimize an angle (e.g. uptilt angle) of antenna(s) (e.g. antenna panel). If there is a change in UAV environmental characteristics, the optimal network parameters may change. If optimization of the network parameters is continuously required, methods of utilizing the existing RSs and/or methods of utilizing additional RSs may be performed. When the additional RSs are utilized, neural network training may be performed according to an operation sequence shown in FIG. 14. In this case, DL overhead (e.g. DL subframe overhead) and/or UL overhead (e.g. UL subframe overhead) may be minimized.

The entity that initiates training of the neural network may be the base station or non-terrestrial terminal. The training entity of the neural network may be the base station or non-terrestrial terminal. The training entity may train the neural network (S1401). The training entity may determine whether the prediction accuracy of the trained neural network satisfies the determination criteria (S1402). If the prediction accuracy of the trained neural network satisfies the determination criteria, the training entity may set an LI to a first value (e.g. 0) (S1403). If the training entity and the training initiating entity are different, the training entity may transmit the LI set to the first value to the training initiating entity (S1403). The LI set to the first value may indicate an increase in the transmission periodicity of the initiation signal. In the step S1404, the training initiating entity may increase the transmission periodicity of the initiation signal and transmit the initiation signal according to the increased transmission periodicity. In this case, a NOT, which is a determination periodicity of the neural network's prediction accuracy, may also increase. Accordingly, the overhead for signaling the initiation signal and/or determining the prediction accuracy of the neural network can be reduced.

If the prediction accuracy of the trained neural network does not satisfy the determination criteria, the training entity may set the LI to a second value (e.g. 1) (S1405). If the training entity and the training initiating entity are different, the training entity may transmit the LI set to the second value to the training initiating entity (S1405). The LI set to the second value may indicate a decrease in the transmission periodicity of the initiation signal. In the step S1406, the training initiating entity may reduce the transmission periodicity of the initiation signal and transmit the initiation signal according to the reduced transmission periodicity. In this case, the NOT, which is a determination periodicity of the neural network's prediction accuracy, may also be reduced.

When the UAV characteristic parameters and/or environmental characteristic parameters change, optimization of the network parameters may be required. For example, when the altitude of a non-terrestrial terminal rises, a beam set used for communication with the non-terrestrial terminal may change, and the angle (e.g. uptilt angle) of the antenna (e.g. antenna panel) of the base station communicating with the non-terrestrial terminal may be changed adaptively.

When the UAV characteristic parameters and/or environmental characteristic parameters change, the prediction accuracy of the neural network may deteriorate. In this case, the transmission periodicity of the initiation signal and the NOT may be restored to their initial values (e.g. default values). In other words, the transmission periodicity of the initiation signal may be reduced, and the NOT may be reduced. The training initiating entity may transmit the initiation signal according to the reduced transmission periodicity (e.g. initial transmission periodicity), and transmission of the NPS may be triggered by the initiation signal. The training entity may train the neural network according to the reduced NOT (e.g. initial NOT).

The training entity may be changed in the training procedure of the neural network. The model, parameters, and the like of the utilized neural network may be shared/exchanged between the base station and non-terrestrial terminals, between non-terrestrial terminals, and/or between base stations. The training and operation methods for optimizing the network parameters may be performed in various ways.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a first communication node, comprising:
transmitting, to a second communication node, an initiation signal indicating to initiate a collection procedure of training data for a neural network;
transmitting, to the second communication node, an information signal including network parameters of the first communication node;
receiving, from the second communication node, the training data in response to the information signal;
training the neural network using the training data;
determining optimal network parameters using the trained neural network; and
performing communication with the second communication node using the optimal network parameters.

2. The method according to claim 1, wherein the first communication node is a terrestrial base station, and the second communication node is a non-terrestrial terminal.

3. The method according to claim 1, wherein when a prediction accuracy of the neural network does not satisfy determination criteria, at least one of the initiation signal or the information signal is transmitted to the second communication node.

4. The method according to claim 1, wherein when a prediction accuracy of the trained neural network satisfies determination criteria, a transmission periodicity of the initiation signal increases, and when the prediction accuracy of the trained neural network does not satisfy the determination criteria, the transmission periodicity of the initiation signal decreases.

5. The method according to claim 1, wherein the network parameters include a distance between the first communication node and another communication node, a location of the first communication node, an antenna angle of the first communication node, a number of sectors of the first communication node, a beam set of the first communication node, or a beamforming vector of the first communication node, and the information signal is a reference signal or a control signal.

6. The method according to claim 1, wherein the training data includes at least one of performance metrics for the network parameters, unmanned aerial vehicle (UAV) characteristic parameters, or environmental characteristic parameters, the UAV characteristic parameters are parameters indicating characteristics of the second communication node that is a UAV, and the environmental characteristic parameters are parameters that affect communication between the first communication node and the second communication node in addition to the network parameters and the UAV characteristic parameters.

7. The method according to claim 1, wherein the determining of the optimal network parameters comprises:
generating a signal quality map using the trained neural network when a prediction accuracy of the trained neural network satisfies determination criteria; and
determining the optimal network parameters using the signal quality map.

8. The method according to claim 7, wherein an input of the trained neural network includes a distance between the first communication node and another communication node, an antenna angle of the first communication node, and an altitude of the second communication node, an output of the trained neural network includes a wideband signal to interference plus noise ratio (SINR), and the signal quality map is a wideband SINR map.

9. A method of a first communication node, comprising:
receiving, from a second communication node, an initiation signal indicating to initiate a collection procedure of training data of a neural network;
in response to the initiation signal, transmitting, to the second communication node, an information signal including network parameters of the first communication node;
receiving, from the second communication node, the training data in response to the information signal;
training the neural network using the training data;
determining optimal network parameters using the trained neural network; and
performing communication with the second communication node using the optimal network parameters.

10. The method according to claim 9, wherein when a prediction accuracy of the trained neural network satisfies determination criteria, information on an increased transmission periodicity of the initiation signal is transmitted to the second communication node, and when the prediction accuracy of the trained neural network does not satisfy the determination criteria, information on a decreased transmission periodicity of the initiation signal is transmitted to the second communication node.

11. The method according to claim 9, wherein the network parameters include a distance between the first communication node and another communication node, a location of the first communication node, an antenna angle of the first communication node, a number of sectors of the first communication node, a beam set of the first communication node, or a beamforming vector of the first communication node, and the information signal is a reference signal or a control signal.

12. The method according to claim 9, wherein the training data includes at least one of performance metrics for the network parameters, unmanned aerial vehicle (UAV) characteristic parameters, or environmental characteristic parameters, the UAV characteristic parameters are parameters indicating characteristics of the second communication node that is a UAV, and the environmental characteristic parameters are parameters that affect communication between the first communication node and the second communication node in addition to the network parameters and the UAV characteristic parameters.

13. The method according to claim 9, wherein the determining of the optimal network parameters comprises:
generating a signal quality map using the trained neural network when a prediction accuracy of the trained neural network satisfies determination criteria; and
determining the optimal network parameters using the signal quality map.

14. A method of a second communication node, comprising:
transmitting, to a first communication node, an initiation signal indicating to initiate a collection procedure of training data for a neural network;
in response to the initiation signal, receiving, from the first communication node, an information signal including network parameters of the first communication node;
generating the training data based on the information signal;
training the neural network using the training data;
determining optimal network parameters using the trained neural network; and
transmitting information on the optimal network parameters to the first communication terminal.

15. The method according to claim 14, wherein the first communication node is a terrestrial base station, and the second communication node is a non-terrestrial terminal.

16. The method according to claim 14, wherein when a prediction accuracy of the trained neural network satisfies determination criteria, a transmission periodicity of the initiation signal increases, and when the prediction accuracy of the trained neural network does not satisfy the determination criteria, the transmission periodicity of the initiation signal decreases.

17. The method according to claim 14, wherein the network parameters include a distance between the first communication node and another communication node, a location of the first communication node, an antenna angle of the first communication node, a number of sectors of the first communication node, a beam set of the first communication node, or a beamforming vector of the first communication node, and the information signal is a reference signal or a control signal.

18. The method according to claim 14, wherein the training data includes at least one of performance metrics for the network parameters, unmanned aerial vehicle (UAV) characteristic parameters, or environmental characteristic parameters, the UAV characteristic parameters are parameters indicating characteristics of the second communication node that is a UAV, and the environmental characteristic parameters are parameters that affect communication between the first communication node and the second communication node in addition to the network parameters and the UAV characteristic parameters.

19. The method according to claim 14, wherein the determining of the optimal network parameters comprises:
generating a signal quality map using the trained neural network when a prediction accuracy of the trained neural network satisfies determination criteria; and
determining the optimal network parameters using the signal quality map.

20. The method according to claim 19, wherein an input of the trained neural network includes a distance between the first communication node and another communication node, an antenna angle of the first communication node, and an altitude of the second communication node, an output of the trained neural network includes a wideband signal to interference plus noise ratio (SINR), and the signal quality map is a wideband SINR map.
